(19) United States
(12) Patent Application Publication
(10) Pub. No.: US 2004/0046546 A1
(43) Pub. Date: Mar. 11, 2004

(54) Mobile detection system

(76) Inventor: Kunihiro Kishida, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/625,658

(22) Filed: Jul. 24, 2003

(30) Foreign Application Priority Data
Aug. 13, 2002 (JP) 2002-235669

(51) Int. Cl. G01P 3/66; G01B 7/14

(52) U.S. Cl. 324/179; 324/207.26

(57) ABSTRACT

The object of the present invention is to provide a less expensive, highly reliable mobile detection system that can be maintained easily.

A mobile detection system according to the present invention includes a plurality of magnetic members arranged in a predetermined arrangement pattern whereby an installation place can be discriminated, and a mobile that has magnetic sensors capable of detecting external magnetic fields of the magnetic members and passes over a place having the magnetic members installed therein. When the mobile has passed over a place having the magnetic members installed therein, the place having the magnetic members installed therein over which the mobile has passed is discriminated on the basis of an arrangement pattern obtained from external magnetic fields of the magnetic members detected by the magnetic sensors. In addition, the mobile detection system according to the present invention can conduct determination of the passing velocity and passing time of a mobile and identification of the mobile, at the time when the mobile has passed over a place having the magnetic members installed therein.

### BACKGROUND OF THE INVENTION

1. Field of the Invention

The present invention relates to a mobile detection system for discriminating a place having magnetic members installed therein over which a mobile having magnetic sensors has passed. In particular, the present invention relates to a mobile detection system for discriminating a place having magnetic members installed therein over which a mobile has passed on the basis of an arrangement pattern obtained from external magnetic fields of the magnetic members detected by magnetic sensors when the mobile has passed over the place having the magnetic members installed therein.

2. Description of the Related Art

As an example of a conventional train detection system, there is known a system in which rails are partitioned at intervals of 200 to 1000 m and insulated, and a signal current is let flow through the partitioned rails to detect the existence of a train. This train detection system is called track circuit as well. The principle of this train detection system is as follows: when there is no train, a signal current flows between ends of partitioned rails; and when there is a train, a signal current is prevented from flowing between the ends of the partitioned rails by a short circuit between the rails caused by wheels and axles of the train. In other words, the system detects whether or not there is a train on the track circuit by monitoring the signal current.

As another example of a train detection system, there is known a system in which a plurality of radio devices are installed along stations and railroad tracks and a device is mounted on each train and the presence of a train, that is in such a range that transmission and reception are possible with respect to a signal transmitted from a radio device, is detected by monitoring a response transmitted from the device mounted on the train in response to a signal transmitted from the radio device. This train detection system can also measure the time required for transmission and reception of the radio signals conducted between the radio device and the device mounted on the train, and thereby determine the distance between the train having the device and the radio device on the basis of the propagation velocity of the radio signals.

The above-described train detection system using the track circuit can ascertain whether or not there is a train on the track circuit through which a signal current is let flow, but cannot identify the place of the train on the track circuit. Furthermore, since the number of trains present on the track circuit cannot be identified, the intervals of train run are short and the above-described train detection system cannot be applied to a section having a possibility of presence of a plurality of trains on the track circuit. In addition, it is necessary to take into consideration the influence of a weather change (such as rainfall or snow) on the intensity of the signal current that flows through rails. In addition, it is necessary to conduct maintenance on a device for supplying a signal current to the track circuit and a device for detecting the signal current on the track circuit. In addition, there is also a problem that working of such maintenance must be conducted at night during which trains do not pass.

On the other hand, in the train detection system using the radio device and the device mounted on the train, a plurality of expensive radio devices must be installed along stations and railroad tracks. In addition, the installed radio devices must be supplied with electric power in order to conduct transmission and reception of the radio signals with the device mounted on the train. This results in a problem that it costs a great deal to install and maintain such radio devices.

### SUMMARY OF THE INVENTION

A mobile detection system according to the present invention solves the above-described problems, and provides a less expensive, highly reliable mobile detection system that can be maintained easily.

A mobile detection system according to the present invention is a mobile detection system including a plurality of magnetic members arranged in a predetermined arrangement pattern whereby an installation place can be discriminated, and a mobile that has magnetic sensors capable of detecting external magnetic fields of the magnetic members and passes over a place having the magnetic members installed therein, wherein when the mobile has passed over a place having the magnetic members installed therein, the place having the magnetic members installed therein over which the mobile has passed is discriminated on the basis of an arrangement pattern obtained from external magnetic fields of the magnetic members detected by the magnetic sensors.

The magnetic members used in the mobile detection system according to the present invention are, for example, permanent magnets. Therefore, the magnetic members are inexpensive and can be easily installed. In addition, they are not necessary to be supplied with energy. Further, once the magnetic members which are permanent magnets are installed, the maintenance thereof is not necessary. Still further, the performance of the magnetic members and magnetic sensors are hardly affected by the weather, such as rainfall and snow.

In the mobile detection system according to the present invention, the arrangement pattern of the magnetic members includes two magnetic members installed being spaced from each other in a travel direction of the mobile by a predetermined distance, and when the mobile has passed over a place having the magnetic members installed therein, a passing velocity of the mobile at the time when the mobile has passed between the two magnetic members is determined on the basis of a time interval at which the magnetic sensors detect external magnetic fields of the two magnetic members.

Since the arrangement pattern of the magnetic members includes two magnetic members installed being spaced from each other in the travel direction of the mobile by a predetermined distance, it is possible to discriminate a place having the magnetic members installed therein over which the mobile has passed and determine the passing velocity of the mobile at the time when the mobile has passed over the place having the magnetic members installed therein.

In the mobile detection system according to the present invention, the mobile further includes a clock unit, and a storage unit for storing information capable of identifying the mobile, passing time of the mobile at the time when the mobile has passed over a place having the magnetic members installed therein is determined on the basis of time information supplied from the clock unit, and the mobile that has passed over the place having the magnetic members installed therein is identified on the basis of information stored in the storage unit.

The passing time at the time when the mobile has passed over a place having the magnetic members installed therein can be determined on the basis of time information supplied from the clock unit. And the mobile can be identified on the basis of information stored in the storage unit. Therefore, it is possible to discriminate the place having the magnetic members installed therein over which the mobile has passed, determine the passing time of the mobile at the time when the mobile has passed over the place, and identify the mobile.

In the mobile detection system according to the present invention, each of the magnetic members includes a plurality of magnets arranged in a straight line, and the magnets are installed so as to direct predetermined same polarities in a predetermined direction generally perpendicular to a straight line direction in which the magnets are arranged so as to be adjacent to each other.

By using magnets thus formed as magnetic members, the distance over which magnetic sensors such as ordinary Hall elements can detect external magnetic fields of the magnetic members can be extended. For example, by using such magnetic members, the distance at which external magnetic fields of the magnetic members can be detected can be extended to approximately 60 to 90 cm. For example, detecting the external magnetic fields of such magnetic members installed on the crossties can be performed with a configuration having magnetic sensors installed on the bottom of the train.

Hereafter, an embodiment of the present invention will be described with reference to accompanying drawings.

### BRIEF DESCRIPTION OF THE DRAWINGS

FIG. 1 is a diagram showing an embodiment of a mobile detection system according to the present invention.

FIG. 2 is a diagram showing an example of a mobile control system including a mobile detection system and a central controlling unit according to the present invention.

FIG. 3 is a diagram showing an example of magnetic field detection signals detected by magnetic sensors.

FIG. 4 is a diagram showing a method for determining a passing velocity of a train and discriminating a passing position.

FIG. 5 is a diagram showing an example of a magnet configuration of a magnetic member.

### DESCRIPTION OF THE PREFERRED EMBODIMENTS

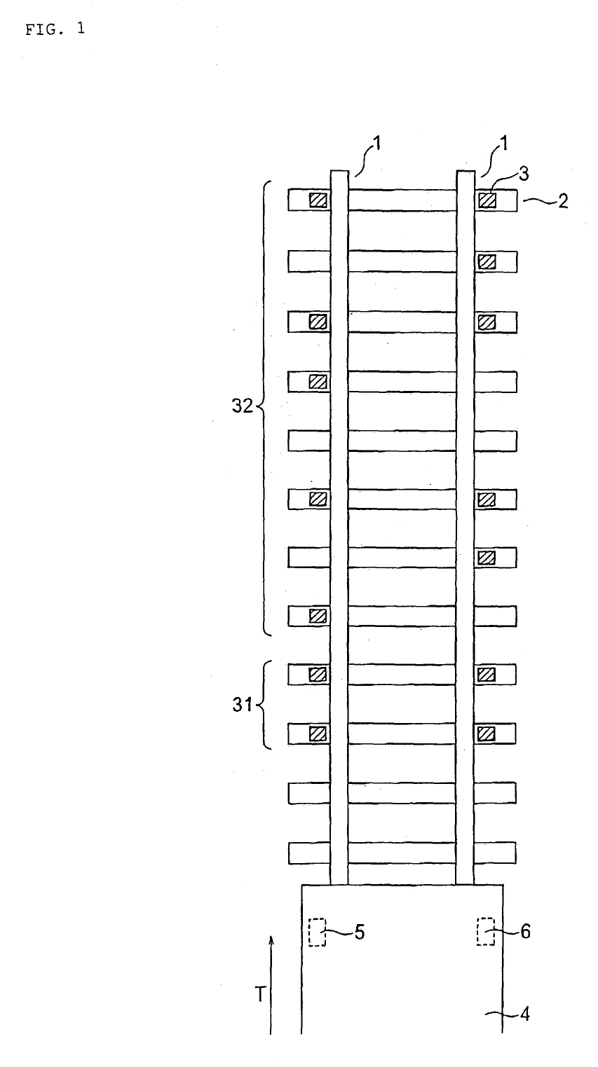

FIG. 1 shows an embodiment of a mobile detection system according to the present invention.

In FIG. 1, two rails 1 are shown, and a train 4 runs on the rails 1. The rails 1 are mounted on crossties 2. Magnetic members 3 are installed on the crossties 2. In the example shown in FIG. 1, the magnetic members 3 are installed on the crossties 2 at both sides of the two rails 1 on the basis of a predetermined arrangement pattern. Two magnetic sensors 5 and 6 for detecting external magnetic field of the magnetic members 3 are provided on the train 4. The magnetic sensors 5 and 6 are installed on the bottom of the train 4 in such positions that the magnetic sensors 5 and 6 pass over magnetic members 3 when the train 4 passes over a crosstie 2 having the magnetic members 3 installed thereon.

The predetermined arrangement pattern according to which the magnetic members are installed will now be described.

In the example shown in FIG. 1, a plurality of magnetic members 3 are installed on the crossties 2 at both sides of the rails 1 on the basis of the predetermined arrangement pattern. Two kinds of information can be represented according to whether or not a magnetic member 3 is present in a specific position in the arrangement pattern. In the example shown in FIG. 1, one crosstie 2 can have two installation positions for magnetic members 3, and consequently four (=2×2) kinds of information can be represented by using one crosstie 2. Such crossties 2 are installed at predetermined distance intervals in the travel direction of the train 4 on the basis of the arrangement pattern.

In the example shown in FIG. 1, the arrangement pattern of the magnetic members includes a region 31 for recognizing the start of the detection of the arrangement pattern, determining the passing time, identifying the train 4, and detecting the passing velocity of the train 4, and a region 32 for discriminating a passing place, along a travel direction of the train 4 indicated by an arrow T.

If the crossties 2 having the magnetic members 2 installed thereon are arranged at the same distance intervals and the train 4 runs over the crossties 2 having such magnetic members 3 installed thereon at the same passing velocity, then the time interval required for the train 4 to pass over the distance intervals between the crossties 2 becomes the same. According to whether or not the magnetic sensors 5 and 6 generate magnetic field detection signals at the time interval to be detected if the magnetic members 3 are installed based on detection of magnetic fields, the arrangement pattern of the magnetic members 3 can be detected.

However, it is considered that the velocity of the train 4 at the time when the train 4 passes over a place having such magnetic members 3 installed therein is not always constant, but changes. Therefore, it is necessary to provide the region 31 for recognizing the start of the detection of the arrangement pattern, determining the passing time, identifying the train 4, and detecting the passing velocity of the train 4, ahead of the region 32 for discriminating the passing place, and determine a time interval at which the train 4 detects the external magnetic field of the magnetic members 3 installed on the two crossties 2, i.e., the passing velocity at the time when the train 4 passes over the place having the magnetic members 3 installed therein.

Assuming that the number of passing places of the train 4 to be identified is, for example, two hundred thousand. Since 4⁹=262,144, it becomes possible to discriminate such places by using nine crossties 2. In other words, if magnetic members 3 are installed in two positions on one crosstie 2 and an arrangement pattern of magnetic members 3 in a 2 by 9 matrix form is used, then two hundred thousand installation places can be discriminated. In addition, two more crossties 2 become necessary in order to determine the passing velocity of the train, and a total of eleven crossties 2 are needed. As an example, if the interval between the crossties 2 is approximately 50 cm, then eleven crossties 2 bring about a distance of a total of approximately 5 m. By thus installing the magnetic members 3 over a relatively short distance range, it becomes possible to discriminate the two hundred thousand places where the train 4 passes and determine the passing velocity of the train 4.

As described in detail later, the magnetic member 3 includes a plurality of magnets arranged in a straight line. The magnetic member is inexpensive, and it can be easily installed on the crosstie. The magnets function permanently without being supplied with energy, and the maintenance thereof is not needed. Further, the magnets are hardly influenced by the weather and temperature.

Each of the magnetic sensors 5 and 6 may be a sensor using an ordinary Hall element.

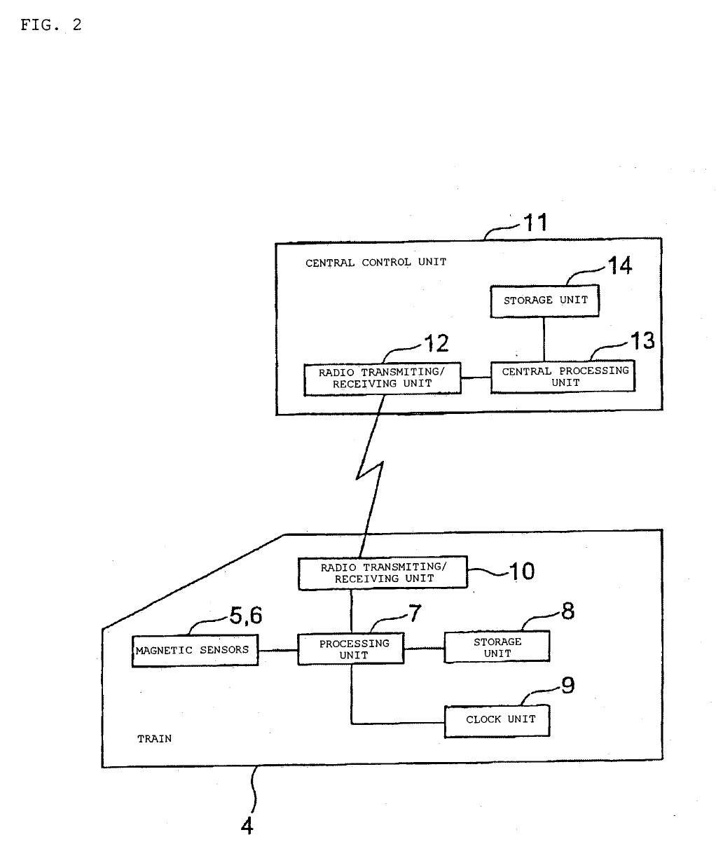

FIG. 2 shows an example of a mobile control system including a mobile detection system according to the present invention and a central control unit.

The train 4 includes the magnetic sensors 5 and 6, a processing unit 7, a storage unit 8, a clock unit 9 and a radio transmitting/receiving unit 10.

The magnetic sensors 5 and 6 are connected to the processing unit 7. Each of the magnetic sensors 5 and 6 detects the magnetic field and sends out a magnetic field detection signal. The processing unit 7 is further connected to the storage unit 8, the clock unit 9, and the radio transmitting/receiving unit 10.

Data concerning places each having the magnetic members 3 installed therein and the arrangement patterns of the magnetic members 3 respectively corresponding to the installation places are stored in the storage unit 8. In addition, the storage unit 8 can store ID information that can identify the train 4. Besides, the storage unit 8 can store history, such as a maintenance record and an accident record, of the train, information concerning drivers, and information concerning carried freight in the case of a freighter, as well. Especially in the case where the train 4 is a freighter, the storage unit 8 can store information concerning freight unloaded at a station on the way and information concerning still carried freight, and transmit those kinds of information to the central control unit 11 via the radio transmitting/receiving unit 10.

The processing unit 7 can determine the passing velocity of the train 4 at the time when the train 4 passes over a place having the magnetic members 3 installed therein on the basis of the magnetic field detection signal output from the magnetic sensors 5 and 6, and discriminate the place having the magnetic members 3 installed therein over which the train 4 has passed, by referring to the arrangement patterns of the magnetic members 3 stored in the storage unit 8.

The processing unit 7 is further connected to the clock unit 9. The processing unit 7 can determine the time when the train 4 has passed a place having the magnetic members 3 installed therein, on the basis of time information in the clock unit.

The processing unit 7 is further connected to the radio transmitting/receiving unit 10 for transmitting a radio signal to the outside and receiving a signal from the outside. The radio transmitting/receiving unit 10 can communicate with a radio transmitting/receiving unit 12 in the central control unit 11 via a radio network.

The central control unit 11 includes the radio transmitting/receiving unit 12, a central processing unit 13, and a storage unit 14. The central control unit 11 controls running of the train 4 on the basis of specific information, passing place, passing velocity and passing time of the trains transmitted from the plurality of trains 4. The central processing unit 13 in the central control unit 11 can store information of these information transmitted from the train 4, execute predetermined processing, and transmit a command of stop, deceleration or acceleration to the processing unit 7 in the train 4 via the radio transmitting/receiving units 12 and 10, if necessary.

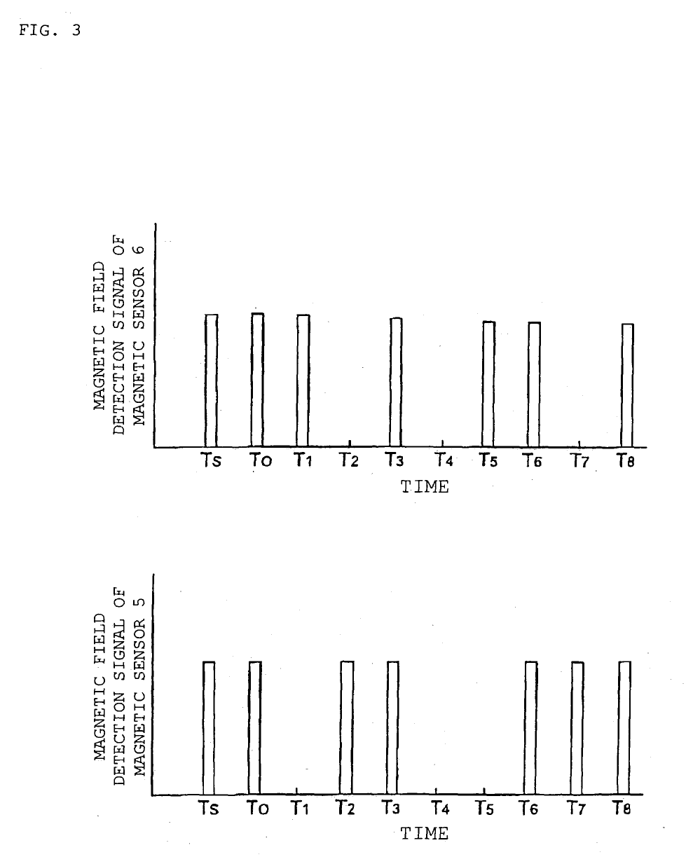

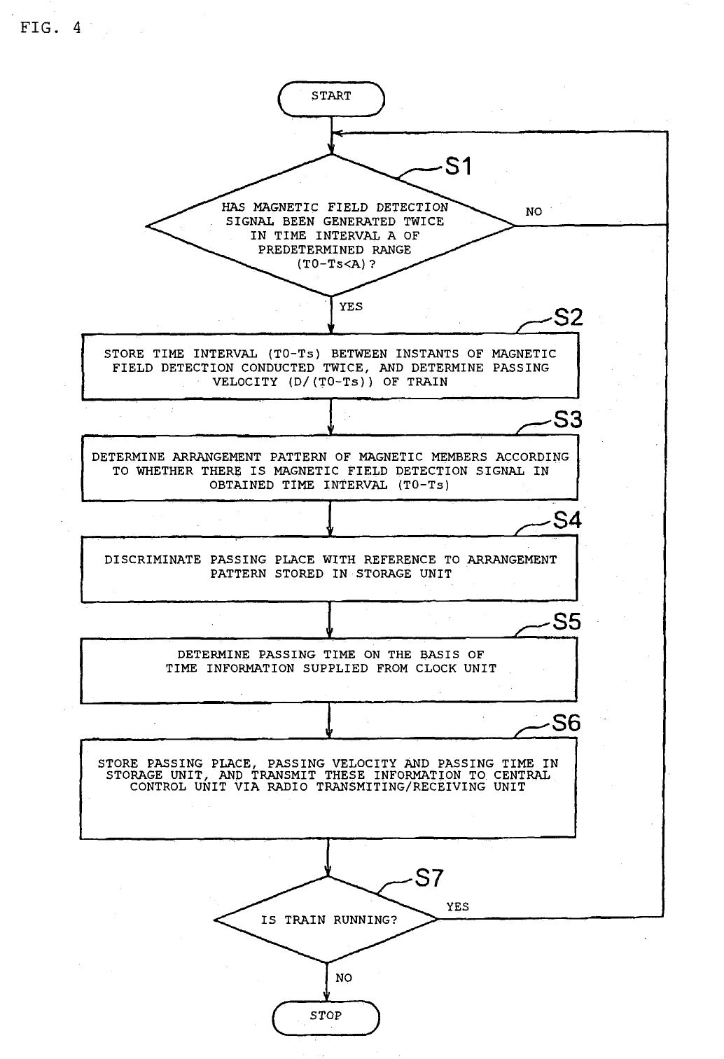

A method for determining the passing velocity of the train 4 and discriminating the passing place will now be described with reference to FIGS. 3 and 4.

FIG. 3 shows an example of magnetic field detection signals detected by magnetic sensors mounted on the train 4.

FIG. 4 shows a method for determining the passing velocity of the train and discriminating the passing position by using the magnetic field detection signal detected by the magnetic sensor shown in FIG. 3.

First, the train 4 goes on the rails 1, and approaches a region having magnetic members 3 installed therein.

Subsequently, in step S1, it is determined whether or not the magnetic field detection signal has been detected twice in a time interval A of a predetermined range. This determination is conducted in order to determine whether or not the velocity of the train 4 passing over a place having the magnetic members 3 installed therein is in an normal range. In other words, when the train 4 runs at a very low velocity, such as at a low velocity immediately before the stop, there is a possibility that an error will occur in detecting the external magnetic field of the magnetic member 3 at predetermined time intervals. The above-described determination is conducted in order to avoid such errors.

If the magnetic field detection signal obtained twice exceeds the time interval A of the predetermined range, then subsequent processing is not conducted. If the magnetic field detection signal obtained twice is within the time interval A of the predetermined range, then the processing proceeds to the next processing step S2, and the passing velocity of the train is obtained.

The step S1 is the step at which the start of the arrangement pattern detecting is recognized and after the train 4 has entered the region 31 for detecting the passing velocity of the train, the two magnetic sensors 5 and 6 mounted on the train 4 detect external magnetic fields of first two magnetic members 3 at time Ts and T0, thereby determining whether or not the difference between Ts and T0, i.e., T0−Ts is equal to the predetermined value A or less.

In the step S2, the time interval (T0−Ts) between magnetic field detection conducted twice is stored in the storage unit 8, and the passing velocity of the train is obtained. If the interval between magnetic members 3, i.e., the interval between crossties 2 is denoted by D, the passing velocity of the train 4 can be obtained by calculating D/(T0−Ts).

Subsequently, the train 4 enters the region 32 for discriminating the passing place of the train from the region 31 for detecting the passing velocity of the train.

In step S3, the arrangement pattern of the magnetic members 3 installed in the region 32 for discriminating the passing place of the train is obtained. In other words, the arrangement pattern of the magnetic members 3 is obtained by checking whether or not the magnetic sensors 5 and 6 detect magnetic field at timing T1, T2, . . . , T9 equivalent to integer times as the detected time interval (T0−Ts) from T0.

Subsequently, in step S4, a passing place is discriminated by referring to the arrangement pattern corresponding to the installation positions stored in the storage unit 8, on the basis of the arrangement pattern obtained in the step S3.

Subsequently, in step S5, passing time when the train 4 has passed over a place having the magnetic members 3 installed therein is determined on the basis of time information supplied from the clock unit 9. Furthermore, the train that has passed over the place having the magnetic members installed therein is identified on the basis of ID information capable of identifying the train 4 stored in the storage unit 8. In addition, in the case where ID information of cars, such as freights or passenger trains, is stored in the storage unit 8, cars that have passed over the place having the magnetic members 3 installed therein are identified.

Subsequently, in step S6, the information concerning the passing position, passing velocity, and passing time of the train 4 respectively determined in the steps S2, S4 and S5 is stored in the storage unit 8. In addition, these information and the train identification information are transmitted to the central control unit 11 via the radio transmitting/receiving unit 10.

Finally, in step S7, it is determined by using a suitable means, whether or not the train 4 is running. If the train 4 is not running, but stopped, then the processing is terminated. If the train 4 is still running, then the processing returns to the step S1 and is repeated.

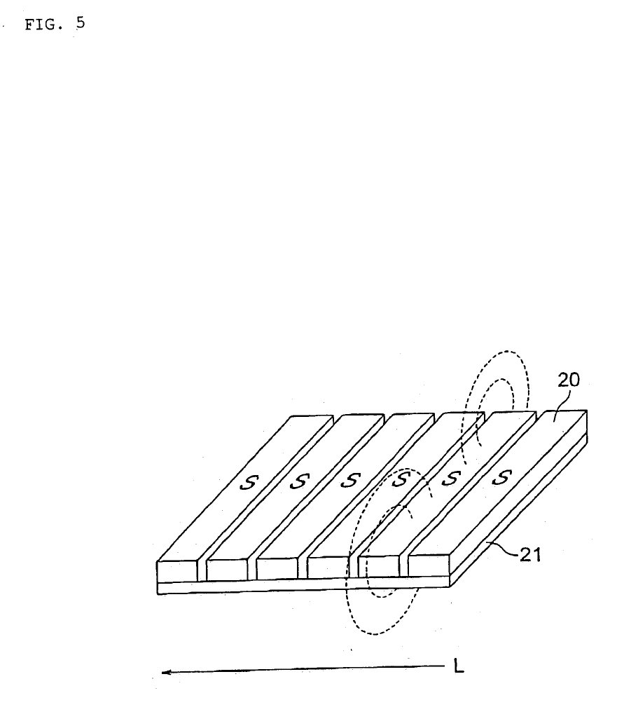

FIG. 5 shows an example of a magnet configuration of a magnetic member which can be used as the magnetic member 3 in the mobile detection system according to the present invention.

In the example shown in FIG. 5, a plurality of magnets 20 are arranged in a direction indicated by L in FIG. 5 in a straight line. The magnets 20 are installed so as to direct the predetermined same poles (S poles) in a predetermined direction generally perpendicular to the straight line direction L and so as to be adjacent to each other. By thus arranging the magnets, especially it becomes possible to extend the magnetic flux from around the boundaries between adjacent same electrodes far away. For example, the distance between each magnetic member 3 installed on each crosstie 2 and the magnetic sensors 5 and 6 mounted on the train 4 can be made to approximately 60 to 90 cm.

As the magnets 20, for example, neodymium magnets can be used. Such magnets 20 can be arranged on a base member 21 made of, for example, iron, and the entire region of each magnet 20 can be covered by a cover made of rubber not shown. The size of the whole magnetic member 3 can be made equal to a several mm to several cm square.

In the above-described embodiment, the magnetic sensors 5 and 6 are mounted on the train 4, and the magnetic members 3 are installed on the crossties 2. However, this embodiment does not limit the scope of the invention. So long as the external magnetic fields can be detected by the magnetic sensors 5 and 6 mounted on the train 4, the magnetic members 3 may be installed anywhere. Further, as for the arrangement of the magnetic members 3, the magnetic members 3 can be arranged arbitrarily instead of arranging magnetic members 3 in twos in a direction traverse to the travel direction of the train. Furthermore, the mobile is not restricted to a train, but an arbitrary mobile can be used. For example, it is also possible to have a variation in which magnetic sensors are provided on a body of a bus as the mobile and magnetic members are installed in a predetermined place such as bus stops.

A mobile detection system according to the present invention includes a plurality of magnetic members arranged in a predetermined arrangement pattern whereby an installation place can be discriminated, and a mobile that has magnetic sensors capable of detecting external magnetic fields of the magnetic members and passes over a place having the magnetic members installed therein. When the mobile has passed over a place having the magnetic members installed therein, the place having the magnetic members installed therein over which the mobile has passed is discriminated on the basis of an arrangement pattern obtained from external magnetic fields of the magnetic members detected by the magnetic sensors. As a result, a less expensive, highly reliable mobile detection system that can be maintained easily is provided. In addition, the mobile detection system according to the present invention can conduct determination of the passing velocity and passing time of a mobile and identification of the mobile, when the mobile has passed over a place having the magnetic members installed therein.

Many widely different embodiments of the present invention may be constructed without departing from the spirit and scope of the present invention. It should be understood that the present invention is not limited to the specific embodiments described in the specification, except as defined in the appended claims.

What is claimed is:

1. A mobile detection system comprising a plurality of magnetic members arranged in a predetermined arrangement pattern whereby an installation place can be discriminated, and a mobile that has magnetic sensors capable of detecting external magnetic fields of the magnetic members and passes over a place having the magnetic members installed therein,
wherein when the mobile has passed over a place having the magnetic members installed therein, the place having the magnetic members installed therein over which the mobile has passed is discriminated on the basis of an arrangement pattern obtained from external magnetic fields of the magnetic members detected by the magnetic sensors.

2. The mobile detection system according to claim 1, wherein
the arrangement pattern of the magnetic members comprises two magnetic members installed being spaced from each other in a travel direction of the mobile by a predetermined distance, and
when the mobile has passed over a place having the magnetic members installed therein, a passing velocity of the mobile at the time when the mobile has passed between the two magnetic members is determined on the basis of a time interval at which the magnetic sensors detect external magnetic fields of the two magnetic members.

3. The mobile detection system according to claim 1 or 2, wherein
the mobile further comprises a clock unit, and a storage unit for storing information capable of identifying the mobile,
passing time of the mobile at the time when the mobile has passed over a place having the magnetic members installed therein is determined on the basis of time information supplied from the clock unit, and the mobile that has passed over the place having the magnetic members installed therein is identified on the basis of information stored in the storage unit.

4. The mobile detection system according to anyone of claims 1 to 3, wherein each of the magnetic members comprises a plurality of magnets arranged in a straight line, and the magnets are installed so as to direct predetermined same polarities in a predetermined direction generally perpendicular to the straight line direction in which the magnets are arranged so as to be adjacent to each other.
